(19) United States
(12) Patent Application Publication
(10) Pub. No.: US 2024/0045781 A1
(43) Pub. Date: Feb. 8, 2024

(54) INFORMATION PROCESSING APPARATUS, INFORMATION PROCESSING METHOD, AND INFORMATION PROCESSING PROGRAM

(71) Applicant: AZBIL CORPORATION, Tokyo (JP)

(72) Inventor: Satoshi YAMAUCHI, Tokyo (JP)

(73) Assignee: AZBIL CORPORATION, Tokyo (JP)

(21) Appl. No.: 18/348,762

(22) Filed: Jul. 7, 2023

(30) Foreign Application Priority Data
Aug. 2, 2022 (JP) 2022-123616

(51) Int. Cl. G06F 11/30

(52) U.S. Cl. CPC G06F 11/3075

(57) ABSTRACT

An information processing apparatus estimates a posterior distribution of a parameter estimate using an identification data set for system identification, performs an evaluation based on a variance of the posterior distribution of the parameter estimate, and an output tracking accuracy evaluation for a case where the parameter estimate is used, and determines, based on evaluation results from an evaluation unit, whether an extraction section for the identification data set is appropriate for use in system identification.

### CROSS-REFERENCE TO RELATED APPLICATIONS

The present application is based on and claims priority to Japanese Application No. 2022-123616, filed Aug. 2, 2022, the entire contents of which are incorporated herein by reference.

### BACKGROUND

### 1. Field of the Disclosure

The present disclosure relates to an information processing apparatus, an information processing method, and an information processing program.

### 2. Description of the Related Art

When a relationship and a phenomenon between a plurality of pieces of data are elucidated, estimated, or controlled, there may be a case where a corresponding system is described as a mathematical model. For example, air-conditioning load forecasting is described using a linear regression model, and a first-order delay system of a process is described using a transfer function model using gain and a time constant. The description of the mathematical model leads back to estimation of a parameter θ, and thus the parameter θ needs to be estimated. As one estimation method, the method of least squares is known, in which in a state where the parameter θ is provided, the parameter θ is sought with which the squared error between an output estimate and an output actual measurement value becomes smallest.

A true value of the parameter of the above-described mathematical model sequentially changes due to, for example, changes of the process over time or changes in use environment, and this may arise a problem. For example, if a control device or the like keeps being designed on the basis of an initially acquired parameter without dealing with changes in parameter true value, there may be a case where the control device or the like cannot provide desirable control performance, and the control device or the like may behave in an unpredictable manner. Thus, system identification (which is defined as “in process control, estimation of a parameter for characterizing response characteristics, such as gain between input data and output data or a time constant, in order to analyze characteristics of a control target or design a control device”, and hereinafter simply referred to as “system identification”) needs to be performed in a sequential manner, and the parameter needs to be periodically updated.

Note that a method is known in which when a parameter is updated, system identification is repeatedly performed on the basis of input-output data acquired in a sequential manner. However, in actuality, all the input-output data that is acquired in a sequential manner cannot be used. For example, the input-output data acquired in a sequential manner include data suitable for system identification such as data clearly representing input-output characteristics, and data unsuitable for system identification such as data significantly affected by noise or the like. If a parameter estimation is performed using, for example, the method of least squares on the basis of the above-described data unsuitable for system identification, a misestimation may be caused. Thus, in order to exclude the above-described misestimation, a technology is known in which the validity of an acquired model is evaluated and determined (for example, see Japanese Patent No. 5768834).

However, in the existing technology, there may be a case where whether or not acquired data itself is suitable for system identification cannot be easily determined.

For example, in a case where data unsuitable for system identification is acquired, not the data but the model may be determined to be erroneous in the existing technology. The existing technology is thus based on the assumption that data suitable for system identification is input, so that deep knowledge and advanced technology are needed to determine whether or not data is suitable for system identification.

### SUMMARY

In order to solve the above-described problems and achieve an object, an information processing apparatus according to the present disclosure includes an estimation unit that estimates a posterior distribution of a parameter estimate using an identification data set (which is data used to perform input-output system identification, and which is hereinafter simply referred to as an “identification data set”) for system identification, an evaluation unit that performs an evaluation based on a variance of the posterior distribution of the parameter estimate, and an output tracking accuracy evaluation for a case where the parameter estimate is used, and a determination unit that determines, based on evaluation results from the evaluation unit, whether an extraction section for the identification data set is appropriate for use in system identification.

According to the present disclosure, an effect is provided in which whether or not obtained data is suitable for system identification can be easily determined.

### BRIEF DESCRIPTION OF THE DRAWINGS

FIG. 1 is a diagram illustrating an example of an overview of an information processing method according to an embodiment;

FIG. 2 is a diagram illustrating an example of a device configuration of the information processing apparatus according to an embodiment;

FIG. 3 is a flow chart illustrating an information processing procedure according to the embodiment;

FIG. 4 is a diagram illustrating an example of graphs regarding output estimate tracking accuracy on an extraction section basis according to the embodiment;

FIG. 5 is a diagram illustrating an example of posterior variances on an extraction section basis according to the embodiment;

FIG. 6 is a diagram illustrating an example of output estimate tracking accuracy for a case where an identification data set suitable for system identification according to the embodiment is used;

FIG. 7 is a diagram illustrating an example of output estimate tracking accuracy for a case where an identification data set unsuitable for system identification according to the embodiment is used;

FIG. 8 is a diagram illustrating, regarding the validity of a parameter according to the embodiment, an example of graphs, which are compared with each other using the sum of squared errors (SSE);

FIG. 9 is a diagram illustrating an example of an evaluation of a parameter estimate variation range according to the embodiment;

FIG. 10 is a diagram illustrating an example of graphs of inputs, a disturbance, and an output actual measurement value of a first modification of the embodiment;

FIG. 11 is a diagram illustrating an example of graphs affected by a misestimation caused in the first modification of the embodiment;

FIG. 12 is a diagram illustrating an example of graphs that avoid the effect of a misestimation caused in the first modification of the embodiment;

FIG. 13 is a diagram illustrating an example of graphs of an input, an output actual measurement value, and variations in parameter of a second modification of the embodiment;

FIG. 14 is a diagram illustrating an example of parameter estimate update in a section suitable for system identification in the second modification of the embodiment; and

FIG. 15 is a hardware configuration diagram illustrating an example of a computer that realizes the functions of the information processing apparatus.

### DETAILED DESCRIPTION

In the following, embodiments will be described with reference to the drawings. Note that, in the following description, constituent elements common to the individual embodiments are denoted by the same reference symbols, and redundant description will be omitted. Moreover, description of these embodiments is not limited to an information processing apparatus, an information processing method, and an information processing program according to the present disclosure. Moreover, for example, numerical values or information described in the present embodiment is not limited to the described content, and this similarly applies to all the following section.

### 1. Overview of Information Processing Method

On the basis of an identification data set for constructing a model, an information processing apparatus 100 according to the present disclosure estimates, using Bayesian inference, a posterior distribution of a parameter estimate and performs an estimation based on the variance of the posterior distribution of the parameter estimate (hereinafter simply referred to as a “posterior variance evaluation”), an output tracking accuracy evaluation for a case where the parameter estimate is used (hereinafter simply referred to as an “output tracking accuracy evaluation”), and a parameter estimate variation evaluation. On the basis of the above-described evaluation results, every time the information processing apparatus 100 acquires an identification data set, the information processing apparatus 100 automatically determines whether the identification data set and an acquisition section for the identification data set are appropriate for use in system identification.

### 1-1. Example of Information Processing

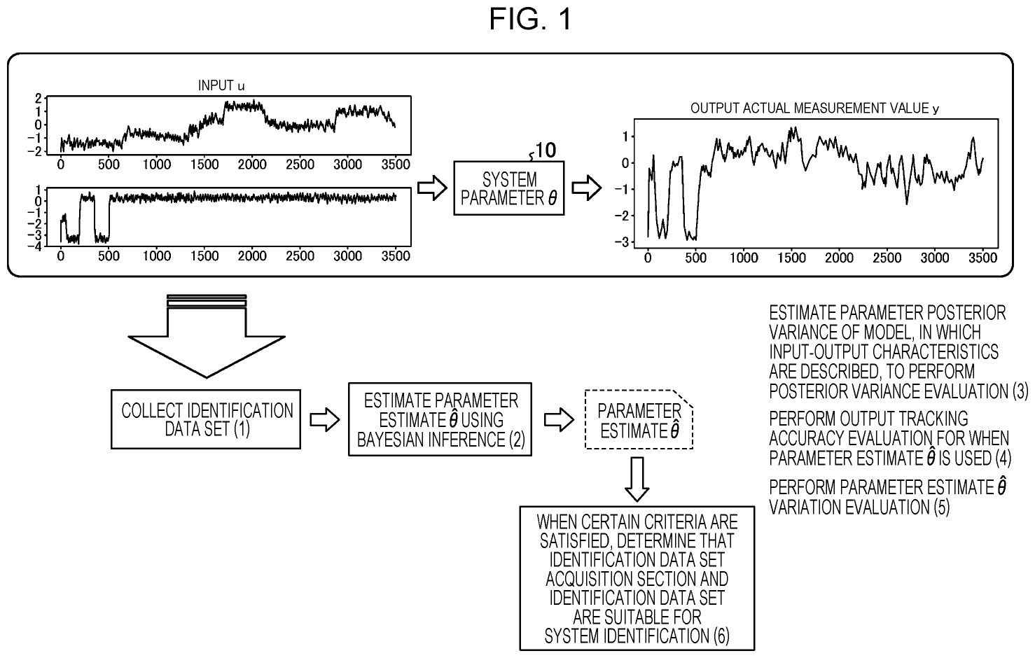

First, the overview of an information processing method performed by the information processing apparatus 100 according to the present disclosure will be described using FIG. 1. In FIG. 1, a system 10 will be described as an example, in which an output actual measurement value y is obtained for inputs u. Suppose that the system 10 is a two-input, one-output system. Furthermore, the system 10 has Expression (1) below as a parameter that characterizes a response characteristic between input data and output data, and the above-described parameter will be hereinafter referred to as a “parameter corresponding to Expression (1)”. Note that data and parameters used by the information processing apparatus 100 in the following section are not limited to the described content.

θ (1)

First, the information processing apparatus 100 collects an identification data set (see (1) in FIG. 1). Subsequently, the information processing apparatus 100 estimates, on the basis of the collected identification data set and using Bayesian inference, a parameter estimate expressed by Expression (2) below (see (2) in FIG. 1). Note that the parameter estimate will be hereinafter referred to as a “parameter estimate corresponding to Expression (2)”.

\hat{θ} (2)

Next, in order to evaluate the validity of the above-described parameter estimate corresponding to Expression (2), the information processing apparatus 100 performs an evaluation using a posterior distribution of the parameter estimate corresponding to Expression (2). First, the information processing apparatus 100 estimates, as a posterior variance evaluation, a parameter posterior variance of a model, in which input-output characteristics are described, to perform a posterior variance evaluation (see (3) in FIG. 1). In the posterior variance evaluation, in order to exclude acquisition of an identification data set in an identification data set acquisition section where the superiority or inferiority of a parameter estimate cannot be evaluated, the information processing apparatus 100 calculates a posterior variance value to determine whether or not the output actual measurement value y is significantly varied when the input u is varied.

Next, the information processing apparatus 100 performs an output tracking accuracy evaluation for when the parameter estimate corresponding to Expression (2) is used (see (4) in FIG. 1). In the output tracking accuracy evaluation, the information processing apparatus 100 calculates the sum of squared errors (hereinafter referred to as the “SSE”) in order to exclude an identification data set that is unsuitable for calculation of a parameter estimate corresponding to Expression (2) with high estimation accuracy. The information processing apparatus 100 determines, using the SSE, whether or not an output estimate, which is expressed by Expression (3) below and calculated on the basis of the parameter estimate corresponding to Expression (2), follows the output actual measurement value y. Note that hereinafter the output estimate will be referred to as an “output estimate corresponding to Expression (3)”.

ŷ (3)

Next, the information processing apparatus 100 performs a parameter estimate variation evaluation (see (5) in FIG. 1). In the parameter estimate variation evaluation, in order to exclude an identification data set for calculating a parameter estimate corresponding to Expression (2), the parameter estimate being shifted away from a parameter true value although a posterior variance evaluation criterion and an output tracking accuracy evaluation criterion are satisfied, the information processing apparatus 100 evaluates whether or not a parameter estimate corresponding to Expression (2) is included in an allowable variation range to determine the validity of the value or order of the parameter estimate corresponding to Expression (2).

In a case where the certain criteria for the posterior variance evaluation, the output tracking accuracy evaluation, and the parameter estimate variation evaluation are satisfied, the information processing apparatus 100 determines that the identification data set and the identification data set acquisition section are suitable for system identification (see (6) in FIG. 1). The certain criteria will be described below. The information processing apparatus 100 calculates, for example, the average of the parameter estimate corresponding to Expression (2) on the basis of determination results, and updates the parameter of the model.

Note that, in the case illustrated in FIG. 1, description has been made in the order of the posterior variance evaluation (3), the output tracking accuracy evaluation (4), and the parameter estimate variation evaluation (5); however, the order is not limited to the one described above, and the evaluations may be performed in a certain order set as appropriate.

### 2. Configuration of Information Processing Apparatus

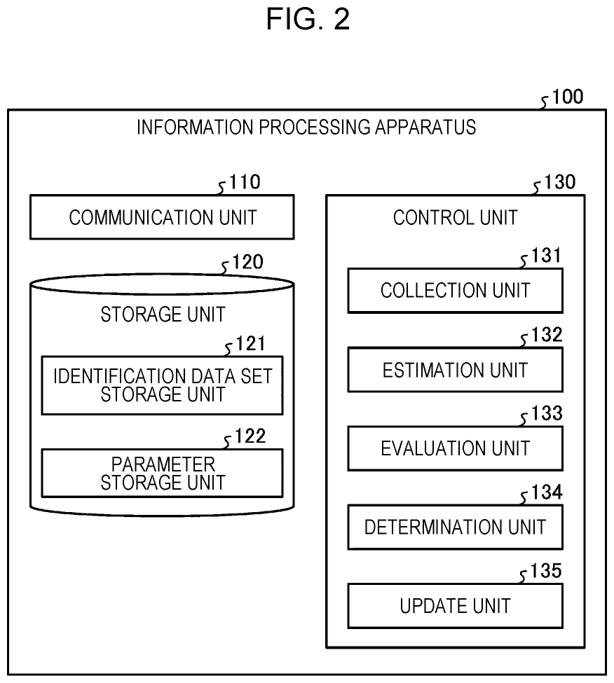

Next, the configuration of the information processing apparatus 100 according to an embodiment will be described using FIG. 2. As illustrated in FIG. 2, the information processing apparatus 100 has a communication unit 110, a storage unit 120, and a control unit 130. Note that, although not illustrated in FIG. 2, the information processing apparatus 100 may have an input unit (for example, a touch screen, a keyboard, or a mouse) for receiving various operations.

### Communication Unit 110

The communication unit 110 is realized by, for example, a network interface card (NIC). The communication unit 110 is connected to a network as needed in a wired or wireless manner, and can transmit and receive information interactively.

### Storage Unit 120

The storage unit 120 has an identification data set storage unit 121 and a parameter storage unit 122. Note that the storage unit 120 is realized by, for example, a semiconductor memory device such as a random access memory (RAM) or a flash memory, or a storage device such as a hard disk or an optical disc.

### Identification Data Set Storage Unit 121

The identification data set storage unit 121 stores an identification data set, which is collected by the information processing apparatus 100 to perform system identification. Note that information stored in the identification data set storage unit 121 is not limited to the above-described identification data set, and the identification data set storage unit 121 may store other information that may become an identification data set.

### Parameter Storage Unit 122

The parameter storage unit 122 stores a parameter, which is calculated through system identification performed by the information processing apparatus 100. Note that information stored in the parameter storage unit 122 is not limited to the above-described parameter calculated through system identification, and the parameter storage unit 122 may store other information that may become a parameter.

### Control Unit 130

The control unit 130 has a collection unit 131, an estimation unit 132, an evaluation unit 133, a determination unit 134, and an update unit 135. Note that the control unit 130 is realized by, for example, a processor, a microprocessing unit (MPU), or a central processing unit (CPU) executing, using a RAM as a work area, various programs stored in the storage unit 120. Moreover, the control unit 130 is realized by an integrated circuit (IC) such as an application specific integrated circuit (ASIC) or a field-programmable gate array (FPGA).

### Collection Unit 131

The collection unit 131 collects an identification data set, which is information used by the information processing apparatus 100 to perform system identification.

### Estimation Unit 132

The estimation unit 132 uses an identification data set for performing system identification to estimate, on the basis of Bayesian inference, a posterior distribution of a parameter estimate corresponding to Expression (2).

Bayesian inference described above differs from the method of least squares, which is an existing method in which an estimation result is obtained as a point. Bayesian inference is a method in which an estimation result can be obtained as a distribution. Furthermore, Bayesian inference is a method in which a new distribution (hereinafter referred to as a “posterior distribution”) is obtained by modifying, on the basis of observed data, a distribution (hereinafter referred to as a “prior distribution”) in which prior knowledge (in FIG. 1, information regarding the parameter corresponding to Expression (1)) is reflected. The posterior distribution obtained by Bayesian inference described above has a greater amount of information such as variance, a range of possible values, or the breadth of the distribution than an estimation result based on the method of least squares and obtained as a point. Thus, the information processing apparatus 100 calculates an estimation result whose reliability can be evaluated using a posterior distribution.

In addition, Bayesian inference can be generally expressed by Equation (7) below when a prior distribution is expressed by Expression (4) below, observed data is expressed by Expression (5) below, and a posterior distribution is expressed by Expression (6) below.

$$p ( θ ) \qquad ( 4 )$$

$${y}_{0 : T} \qquad ( 5 )$$

$$p ( θ \vert {y}_{0 : T} ) \qquad ( 6 )$$

$$p ( θ \vert {y}_{0 : T} ) = \frac{p ( {y}_{0 : T} \vert θ ) p ( θ )}{p ( {y}_{0 : T} )} \qquad ( 7 )$$

Note that the estimation unit 132 has been described as using Bayesian inference as an estimation method; however, the estimation unit 132 may use other estimation methods as long as the other estimation methods can be used to estimate a parameter distribution.

### Evaluation Unit 133

The evaluation unit 133 performs an evaluation based on the variance of the posterior distribution of the parameter estimate, an output tracking accuracy evaluation for a case where the parameter estimate is used, and a parameter estimate variation evaluation. Detailed functions of the evaluation unit 133 will be each specifically described in the following sections, “3-1. Details of Posterior Variance Evaluation”, “3-2. Details of Output Tracking Accuracy Evaluation”, and “3-3. Details of Parameter Estimate Variation Evaluation”. Note that the evaluation unit 133 may perform an evaluation using an evaluation method other than the evaluation method described above. Furthermore, the evaluation unit 133 does not necessarily use a posterior distribution and may use other information as long as it is a probability distribution.

### Determination Unit 134

The determination unit 134 determines, on the basis of evaluation results from the evaluation unit 133, whether an extraction section for the identification data set is appropriate for use in system identification. Furthermore, in a case where evaluation results from the evaluation based on the variance of the posterior distribution of the parameter estimate (the posterior variance evaluation), the output tracking accuracy evaluation for a case where the parameter estimate corresponding to Expression (2) is used (the output tracking accuracy evaluation), and the parameter estimate variation evaluation satisfy predetermined conditions, the determination unit 134 determines whether the extraction section for the identification data set is appropriate for use in system identification.

Specifically, when the determination unit 134 uses an extraction section for an identification data set to perform system identification, in a case where evaluation results from a posterior variance evaluation, an output tracking accuracy evaluation, and a parameter estimate variation evaluation satisfy the predetermined conditions, the determination unit 134 determines that the target identification data set and the extraction section for the target identification data set are suitable for system identification. In contrast, in a case where the above-described conditions are not satisfied, the determination unit 134 determines that the target identification data set and the extraction section for the identification data set are unsuitable for system identification.

Note that, in one example of the present embodiment, the above-described predetermined conditions are satisfied in a case where a posterior variance value is less than or equal to a reference value, an SSE value is less than a reference value, and the parameter estimate corresponding to Expression (2) is within an allowable variation range, which will be described below. Note that the predetermined conditions are not limited to the above-described combination, and the information processing apparatus 100 can set conditions in accordance with response characteristics between input data and output data. For example, the determination unit 134 may make a determination only under the condition that both the posterior variance value and the SSE value are less than or equal to the reference values or that either one of the posterior variance value and the SSE value is less than or equal to the corresponding reference value.

### Update Unit 135

In a case where the determination unit 134 determines that the predetermined conditions are satisfied, the update unit 135 updates the parameter of the model using an average value of the posterior distribution of the parameter estimate corresponding to Expression (2). Note that, in addition to the average value of the posterior distribution, other representative statistics such as a mode or a median may be used. Furthermore, the update unit 135 updates the parameter not only on the basis of the above-described determination result from the determination unit 134 but also, as needed, on the basis of, for example, a command from an administrator.

### 3. Procedure of Information Processing

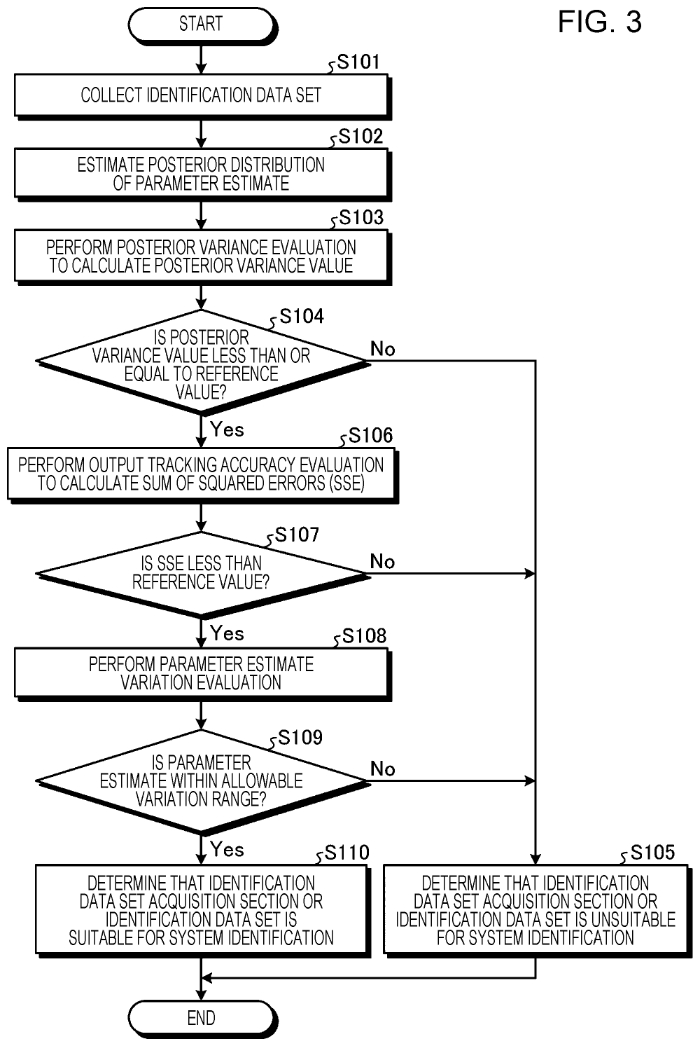

Next, an information processing procedure of the information processing apparatus 100 according to the embodiment will be described. FIG. 3 is a flow chart illustrating an example of the information processing procedure according to the embodiment.

First, the collection unit 131 collects an identification data set (Step S101). Subsequently, on the basis of the identification data set, the estimation unit 132 estimates, using Bayesian inference, a posterior distribution of the parameter estimate corresponding to Expression (2) (Step S102). Next, the evaluation unit 133 performs a posterior variance evaluation to calculate a posterior variance value (Step S103). Subsequently, in a case where the posterior variance value calculated by the evaluation unit 133 is less than or equal to the reference value, the determination unit 134 makes a determination that allows the process to proceed to the next step (Yes in Step S104). In contrast, in a case where the posterior variance value exceeds the reference value, the determination unit 134 determines that an acquisition section for the identification data set is unsuitable for system identification, and the process ends (No in Step S104, and Step S105).

Next, the evaluation unit 133 performs an output tracking accuracy evaluation on the basis of the parameter estimate corresponding to Expression (2) to calculate an SSE value (Step S106). Subsequently, in a case where the SSE value calculated by the evaluation unit 133 is less than the reference value, the determination unit 134 makes a determination that allows the process to proceed to the next step (Yes in Step S107). In contrast, in a case where the SSE value is greater than or equal to the reference value, the determination unit 134 determines that the identification data set is unsuitable for system identification, and the process ends (No in Step S107, and Step S105).

Next, the evaluation unit 133 performs a parameter estimate variation evaluation on the basis of the parameter estimate corresponding to Expression (2) (Step S108). Subsequently, in a case where the parameter estimate corresponding to Expression (2) is within the allowable variation range in the parameter estimate variation evaluation performed by the evaluation unit 133, the determination unit 134 determines, on the basis of the determination result obtained in Step S104 and also the determination result obtained in S107, that the identification data set is suitable for system identification (Yes in Step S109, and S110). In contrast, in a case where the parameter estimate corresponding to Expression (2) is not within the allowable variation range, the determination unit 134 determines that the identification data set is unsuitable for system identification, and the process ends (No in Step S109, and Step S105).

Note that, in the flow chart illustrated in FIG. 3, description has been made in the order of the posterior variance evaluation (Step S103), the output tracking accuracy evaluation (Step S106), and the parameter estimate variation evaluation (Step S108); however, the order is not limited to the one described above, and the evaluations may be performed in a certain order set as appropriate. Moreover, determination conditions in each evaluation may be changed as appropriate.

### 3-1. Details of Posterior Variance Evaluation

Subsequently, the “posterior variance evaluation”, “output tracking accuracy evaluation”, and “parameter estimate variation evaluation” will be described in detail in the following sections. First, the posterior variance evaluation will be described. The evaluation unit 133 performs, using an F-test or the like, an evaluation on the basis of the posterior variance of the parameter estimate corresponding to Expression (2).

In the posterior variance evaluation, the evaluation unit 133 calculates a posterior variance for the determination unit 134 to determine whether or not the acquisition section of the identification data set is an “identification data set acquisition section in which superiority or inferiority of the parameter estimate corresponding to Expression (2) cannot be evaluated”, in other words, an “identification data set acquisition section in which even when a different parameter estimate corresponding to Expression (2) is given, no difference occurs in the output tracking accuracy of an output estimate corresponding to Expression (3) with respect to the output actual measurement value y”.

In more detail, the above-described identification data set acquisition section is unsuitable for system identification because the information processing apparatus 100 cannot narrow down a candidate value of the parameter estimate corresponding to Expression (2), the candidate value being close to the true value of the parameter. In contrast, in the case of “a large difference occurs in the output tracking accuracy of an output estimate corresponding to Expression (3) with respect to the output actual measurement value y in a case where a different parameter corresponding to Expression (1) is given”, it can be said that the identification data set acquisition section is suitable for system identification because it is easy to narrow down a parameter estimate corresponding to Expression (2) with which the tracking accuracy of the output estimate corresponding to Expression (3) with respect to the output actual measurement value y is improved.

The degree to which the above-described candidate value of the parameter estimate corresponding to Expression (2) is narrowed down can be determined on the basis of Bayes' theorem as the magnitude of posterior variance. Specifically, this is expressed by Expression (8) below, and Expression (9) and Expression (10) are in proportion to each other from Expression (8). Thus, in a case where a difference does not occur in Expression (9) even when the value of the parameter corresponding to Expression (1) is changed, Expression (10) has a wide distribution. That is, posterior variance is high.

p(θ|y_{0:T})∝p(y_{0:T}|θ)p(θ) (8)

p(y_{0:T}|θ) (9)

p(θ|y_{0:T}) (10)

Posterior variance represents a confidence factor with respect to an estimation result. On the basis of characteristics of the breadth of the posterior variance, the information processing apparatus 100 determines whether the acquired identification data set is suitable for system identification in accordance with the procedure to be described below. Note that each parameter will be defined as follows, and the defined terms will be used from here. A parameter obtained in the previous system identification will be expressed by Expression (11) below and denoted by a “parameter corresponding to Expression (11)”, a posterior variance of the parameter corresponding to Expression (11) will be expressed by Expression (12) below and denoted by a “posterior variance corresponding to Expression (12)”, a newly acquired parameter will be expressed by Expression (13) below and denoted by a “parameter corresponding to Expression (13)”, and a posterior variance of Expression (13) will be expressed by Expression (14) below and denoted by a “posterior variance corresponding to Expression (14)”.

θ_{old} (11)

σ_{old}² (12)

θ_{new} (13)

σ_{new}² (14)

First, the evaluation unit 133 compares the posterior variance corresponding to Expression (12) with the posterior variance corresponding to Expression (14) using, for example, an F-test. Subsequently, in a case where “the posterior variance corresponding to Expression (12) is greater than or equal to the posterior variance corresponding to Expression (14)” is satisfied, the determination unit 134 determines that the identification data set acquisition section is suitable for system identification from the point of view of posterior variance evaluation.

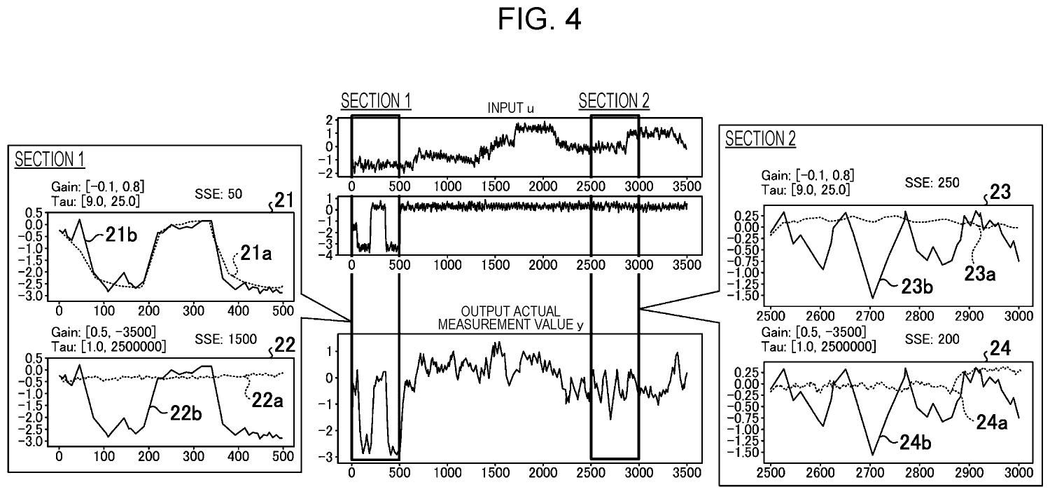

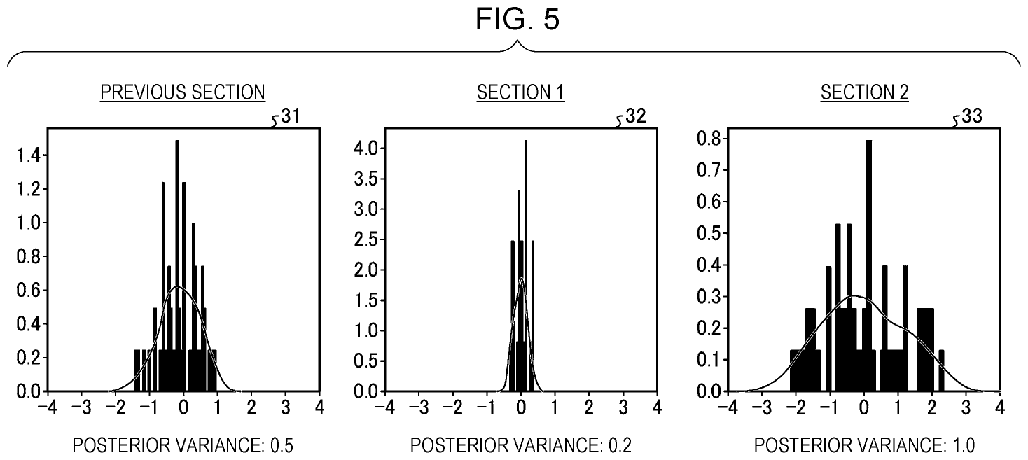

Moreover, the posterior variance evaluation will be further described using FIGS. 4 and 5. First, FIG. 4 is a diagram illustrating graphs in each of which, in a case where a Gain value and a Tau value (a time constant) serving as the parameter estimate corresponding to Expression (2) are set for each identification data set acquisition section, an SSE value is calculated, and the output actual measurement value y and the output estimate corresponding to Expression (3) are plotted. Note that numerical values handled by the information processing apparatus 100 and the graphs illustrated in FIG. 4 are mere examples and are not limited to the information illustrated in FIG. 4.

First, in Section 1, a graph 21 is output in a case where the Gain value is set to [−0.1, 0.8] and the Tau value is set to [9.0, 25.0], and a graph 22 is output in a case where the Gain value is set to [0.5, −3500] and the Tau value is set to [1.0, 2500000]. In the graph 21, a plot 21a representing the output estimate corresponding to Expression (3) follows a plot 21b representing the output actual measurement value y, and the SSE value is “50”.

In contrast, in the graph 22, a plot 22a representing the output estimate corresponding to Expression (3) does not follow a plot 22b representing the output actual measurement value y, and the SSE value is “1500”. From description above, in Section 1, setting an appropriate Gain value and an appropriate Tau value causes the output estimate corresponding to Expression (3) to follow the output actual measurement value y, and thus it can be said that the identification data set acquisition section is suitable for system identification.

Next, in Section 2, a graph 23 is output in a case where the Gain value is set to [−0.1, 0.8] and the Tau value is set to [9.0, 25.0], and a graph 24 is output in a case where the Gain value is set to [0.5, −3500] and the Tau value is set to [1.0, 2500000]. First, in the graph 23, a plot 23a representing the output estimate corresponding to Expression (3) does not follow a plot 23b representing the output actual measurement value y, and the SSE value is “250”.

In contrast, in the graph 24, a plot 24a representing the output estimate corresponding to Expression (3) does not follow a plot 24b representing the output actual measurement value y, and the SSE value is “200”. From description above, in Section 2, regardless of whether an appropriate Gain value and an appropriate Tau value are set or an inappropriate Gain value and an inappropriate Tau value are set, a large difference does not occur in the tracking accuracy of the output estimate corresponding to Expression (3) with respect to the output actual measurement value y, and thus it can be said that the identification data set acquisition section is unsuitable for system identification.

Furthermore, comparisons regarding posterior variance will be described using FIG. 5. FIG. 5 includes graphs for making a comparison between posterior variances of the individual sections illustrated in FIG. 4. First, the evaluation unit 133 estimates, using Bayesian inference, posterior variances having distributions as illustrated in FIG. 5. The evaluation unit 133 calculates results that a posterior variance 31 of the previous section is “variance: 0.5”, a posterior variance 32 of Section 1 is “variance: 0.2”, and a posterior variance 33 of Section 2 is “variance: 1.0”.

On the basis of the result that “the posterior variance 31 of the previous section is greater than or equal to the posterior variance 32 of Section 1”, the determination unit 134 determines that Section 1 is an identification data set acquisition section suitable for system identification. In contrast, since “the posterior variance 33 of Section 2 is greater than or equal to the posterior variance 31 of the previous section”, the determination unit 134 determines that Section 2 is an identification data set acquisition section unsuitable for system identification.

### 3-2. Details of Output Tracking Accuracy Evaluation

Next, the output tracking accuracy evaluation will be described. Regarding the posterior distribution of the parameter estimate corresponding to Expression (2), the evaluation unit 133 performs, using the sum of squared errors, the output tracking accuracy evaluation for a case where the parameter estimate corresponding to Expression (2) is used.

In the output tracking accuracy evaluation, the evaluation unit 133 calculates an SSE value for the determination unit 134 to determine whether the identification data set is an “identification data set with which a parameter estimate corresponding to Expression (2) and resulting in an output estimate corresponding to Expression (3) with high estimation accuracy cannot be calculated”, in other words, whether the identification data set is an “identification data set with which a parameter estimate corresponding to Expression (2) and resulting in an output estimate corresponding to Expression (3) with low tracking accuracy with respect to the output actual measurement value y is calculated”. If the SSE value is low, it can be said that tracking accuracy is high, and thus the SSE can be used as an indicator for tracking accuracy.

Since calculation of an output estimate corresponding to Expression (3) with which the output actual measurement value y is tracked with high accuracy is a premise, the “identification data set with which a parameter estimate corresponding to Expression (2) and resulting in an output estimate corresponding to Expression (3) with low tracking accuracy with respect to the output actual measurement value y is calculated” described above is unsuitable for system identification. Thus, the determination unit 134 makes a determination by calculating the SSE for the tracking accuracy between the output actual measurement value y and the output estimate corresponding to Expression (3) and making a comparison.

Note that, in the present embodiment, description is made on the premise that an evaluation is performed using the SSE; however, the SSE does not have to be used to perform an evaluation. For example, output tracking accuracy can be evaluated using mean absolute error (hereinafter referred to as MAE) or mean squared error (hereinafter referred to as MSE).

Next, the procedure of an output tracking accuracy evaluation performed by the evaluation unit 133 will be described. Note that parameters used in the output tracking accuracy evaluation will be defined as follows, and the defined terms will be used from here. An output estimate in a case where the parameter corresponding to Expression (11) is used will be expressed by Expression (15) below and denoted by an “output estimate corresponding to Expression (15)”. The SSE for the output estimate corresponding to Expression (15) and the output actual measurement value y will be expressed by Expression (16) below and denoted by the “SSE corresponding to Expression (16)”. An output estimate in a case where the parameter corresponding to Expression (13) is used will be expressed by Expression (17) below and denoted by an “output estimate corresponding to Expression (17)”. The SSE for the output estimate corresponding to Expression (17) and the output actual measurement value y will be expressed by Expression (18) and denoted by the “SSE corresponding to Expression (18)”.

ŷ|θ_{old} (15)

SSE_{old} (16)

ŷ|θ_{new} (17)

SSE_{new} (18)

First, the evaluation unit 133 calculates the SSE corresponding to Expression (16) and the SSE corresponding to Expression (18). Subsequently, the determination unit 134 checks the magnitude relationship between the SSE corresponding to Expression (16) and the SSE corresponding to Expression (18). In a case where the SSE corresponding to Expression (16) is greater than the SSE corresponding to Expression (18), the determination unit 134 determines that the parameter corresponding to Expression (13), that is, an identification data set used to calculate the parameter corresponding to Expression (13) is suitable for system identification.

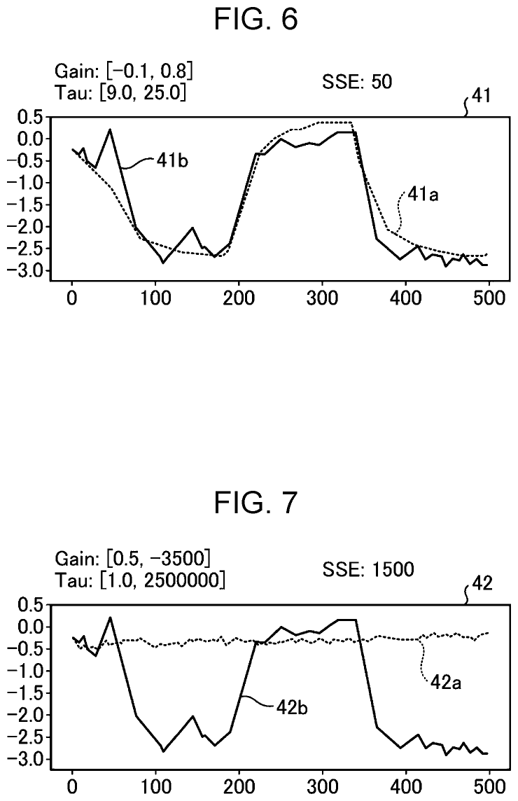

Subsequently, the output tracking accuracy evaluation will be further described using FIGS. 6 and 7. FIGS. 6 and 7 are diagrams of graphs in which, in a case where a Gain value and a Tau value serving as the parameter estimate corresponding to Expression (2) are set, an SSE value is calculated, and the output actual measurement value y and the output estimate corresponding to Expression (3) are plotted. First, in FIG. 6, in a case where the Gain value is set to [−0.1, 0.8] and the Tau value is set to [9.0, 25.0], a graph 41 is output. In the graph 41, a plot 41a representing the output estimate corresponding to Expression (3) follows a plot 41b representing the output actual measurement value y, and the SSE value is “50”.

In contrast, in FIG. 7, in a case where the Gain value is set to [0.5, −3500] and the Tau value is set to [1.0, 2500000], a graph 42 is output. In the graph 42, a plot 42a representing the output estimate corresponding to Expression (3) does not follow a plot 42b representing the output actual measurement value y, and the SSE value is “1500”.

On the basis of the above-described results, the determination unit 134 determines that the parameter estimate corresponding to Expression (2) for the graph 41, that is, the identification data set used to calculate the parameter estimate corresponding to Expression (2) is suitable for system identification.

### 3-3. Details of Parameter Estimate Variation Evaluation

Next, the parameter estimate variation evaluation performed by the evaluation unit 133 will be described. The evaluation unit 133 performs a parameter estimate variation evaluation as to whether the parameter estimate corresponding to Expression (2) is included in a predetermined range of a posterior distribution, which is a comparison target, of the parameter estimate at a different point in time. The parameter estimate variation evaluation aims to exclude an identification data set that is unsuitable for system identification but was not excluded in the “posterior variance evaluation” and “output tracking accuracy evaluation” described above, the identification data set being used to calculate the parameter estimate corresponding to Expression (2).

Specifically, a case is targeted in which both the “posterior variance” and the “SSE” are lower than the reference values; however, the acquired parameter estimate corresponding to Expression (2) has a value that is shifted away from a true value. In order to exclude the identification data set used to calculate the parameter estimate corresponding to Expression (2), which accidentally matches determination criteria for the “posterior variance evaluation” and the “output tracking accuracy evaluation” but is unsuitable for system identification, the determination unit 134 presets an “allowable variation range”, which is defined below, as a reference range for the parameter estimate corresponding to Expression (2). The determination unit 134 determines that the parameter estimate corresponding to Expression (2), which is outside the set allowable variation range, that is, the identification data set used to calculate the parameter estimate corresponding to Expression (2) is unsuitable for system identification.

Next, the procedure of the parameter estimate variation evaluation will be described. First, parameters will be defined as follows, and the defined terms will be used from here. A posterior standard deviation of the parameter corresponding to Expression (11) will be expressed by Expression (19) below and denoted by a “posterior standard deviation corresponding to Expression (19)”, and an allowable variation range of the parameter will be expressed by Expression (20) and denoted by an “allowable variation range corresponding to Expression (20)”.

σ_{old} (19)

R=[θ_{old}−ασ_{old},θ_{old}+ασ_{old}] (20)

First, the determination unit 134 sets, using the posterior standard deviation corresponding to Expression (19), the allowable variation range corresponding to Expression (20). Subsequently, in a case where the parameter corresponding to Expression (13) is within the allowable variation range corresponding to Expression (20), the determination unit 134 determines, from the point of view of parameter estimate variation evaluation, the parameter estimate corresponding to Expression (2), that is, the identification data set used to calculate the parameter estimate corresponding to Expression (2) is suitable for system identification. Note that α described in the allowable variation range corresponding to Expression (20) is a hyperparameter, and is set in advance in accordance with data used in the present disclosure.

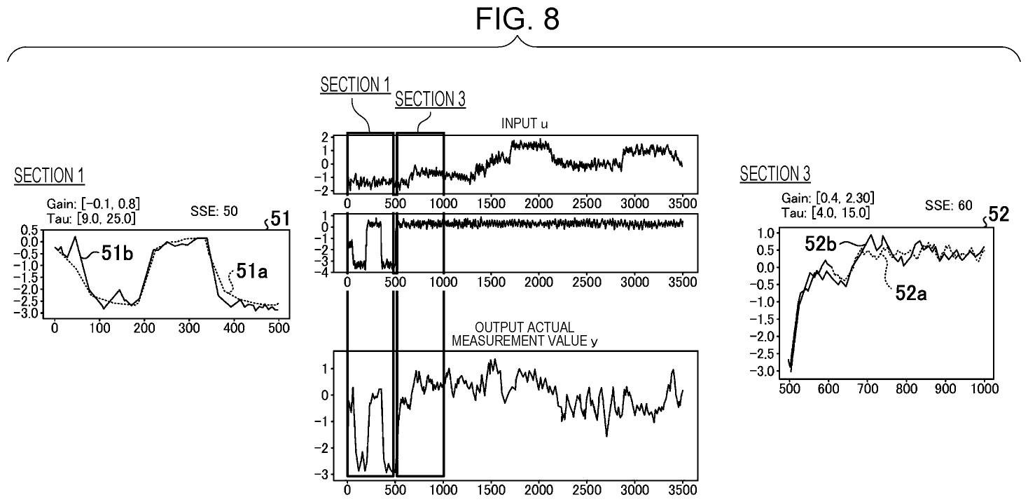

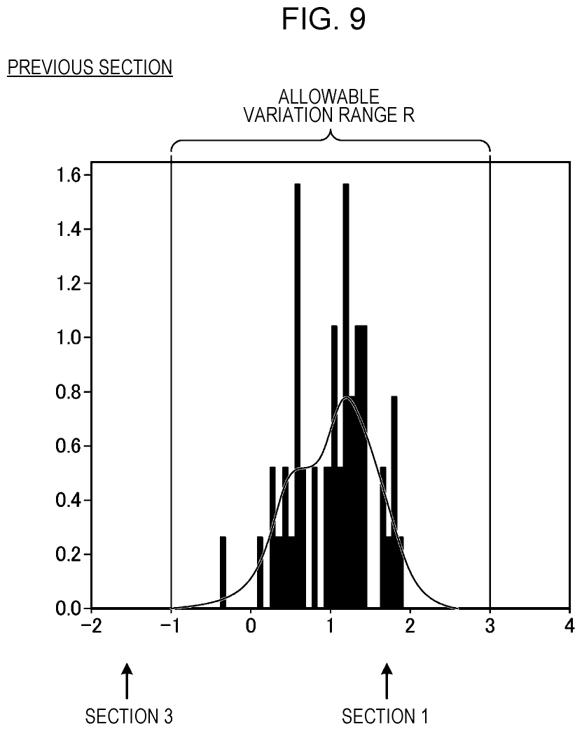

Subsequently, the parameter estimate variation evaluation will be further described using FIGS. 8 and 9. First, FIG. 8 is a diagram of graphs in which an SSE value for a case where a Gain value and a Tau value serving as the parameter estimate corresponding to Expression (2) are set for each identification data set acquisition section is calculated, and the output actual measurement value y and the output estimate corresponding to Expression (3) are plotted.

First, in Section 1, in a case where the Gain value is set to [−0.1, 0.8] and the Tau value is set to [9.0, 25.0], a graph 51 is output. In the graph 51, a plot 51a representing the output estimate corresponding to Expression (3) follows a plot 51b representing the output actual measurement value y, and the SSE value is “50”.

In contrast, in Section 3, in a case where the Gain value is set to [0.4, 2.30] and the Tau value is set to [4.0, 15.0], a graph 52 is output. In the graph 52, a plot 52a representing the output estimate corresponding to Expression (3) follows a plot 52b representing the output actual measurement value y, and the SSE value is “60”.

In the above-described “posterior variance evaluation” and “output tracking accuracy evaluation” for Section 1 and Section 3 illustrated in FIG. 8, the determination unit 134 determines that both the identification data sets used to calculate the parameter estimates corresponding to Expression (2) obtained in Section 1 and Section 3 are suitable for system identification. However, in FIG. 9, when the posterior standard deviation corresponding to Expression (19) is calculated for the parameter corresponding to Expression (11) obtained at the last update, and a comparison is made on the basis of the allowable variation range corresponding to Expression (20) set using the posterior standard deviation corresponding to Expression (19), the parameter corresponding to Expression (13) and obtained in Section 1 is within the allowable variation range corresponding to Expression (20), and the parameter corresponding to Expression (13) and obtained in Section 3 is outside the allowable variation range corresponding to Expression (20). Thus, the determination unit 134 determines that the parameter estimate corresponding to Expression (2) and obtained in Section 1, that is, the identification data set used to calculate the parameter estimate corresponding to Expression (2) and obtained in Section 1 is suitable for system identification.

### 4. Modifications

Next, modifications of the present embodiment will be described.

### 4-1. First Modification: Avoidance of Misestimation

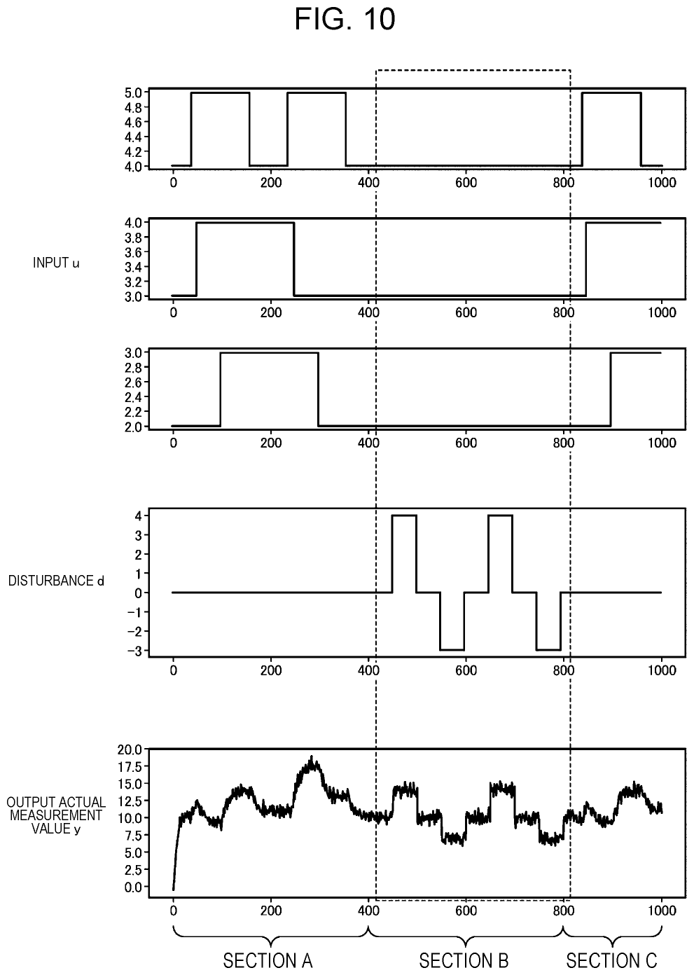

First, an example in which the information processing apparatus 100 avoids a misestimation of the parameter estimate corresponding to Expression (2) will be described using FIGS. 10 to 12. FIG. 10 illustrates, as prior conditions for a first modification, the input u serving as three inputs, a disturbance d, and the output actual measurement value y serving as one output, the disturbance d being an unintentional input. Note that the output actual measurement value y in Section B of FIG. 10 is affected by the disturbance d, and is not the original output actual measurement value y corresponding to the input u but the output measurement value y affected by the disturbance d. Thus, estimation of the parameter in this region may cause a misestimation.

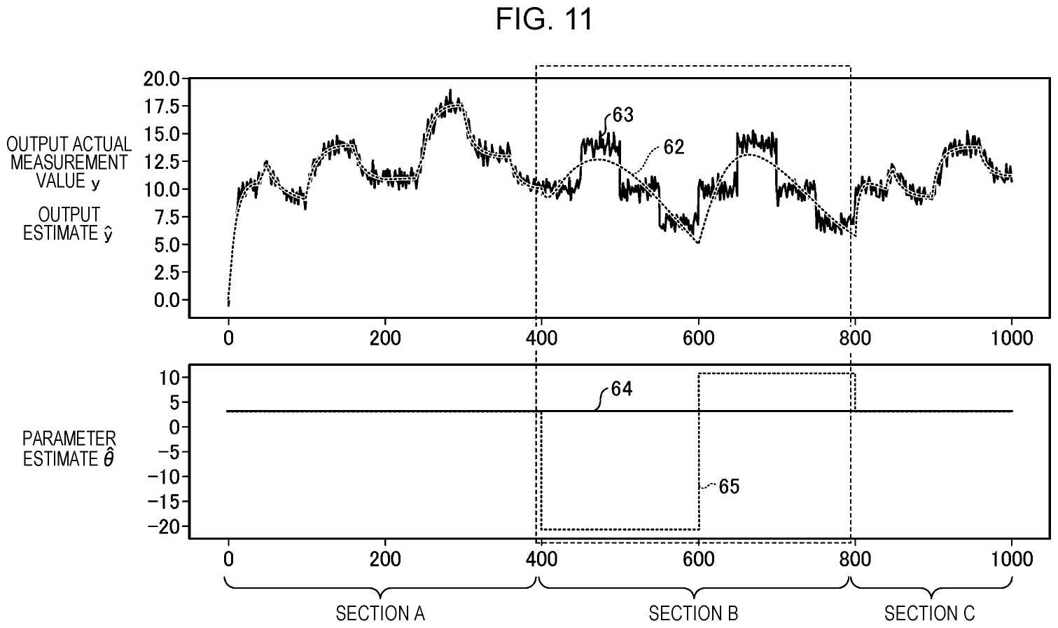

Next, FIG. 11 illustrates plots of the output actual measurement value y and the output estimate corresponding to Expression (3) for a case where a parameter estimation is performed using an existing technology under the input conditions of FIG. 10, and parameter estimate variations. First, in Section A and Section C, which are not affected by the disturbance d, a plot 62 of the output estimate corresponding to Expression (3) follows a plot 63 of the output actual measurement value y with high accuracy, and a parameter true value 64 and a parameter estimate update value 65 for the parameter estimate corresponding to Expression (2) match each other. Thus, it can be said that the parameter estimate corresponding to Expression (2) in Sections A and C, that is, an acquisition section for the input u and the output actual measurement value y used to calculate the parameter estimate corresponding to Expression (2) is suitable for system identification.

In contrast, in Section B, the parameter true value 64 and the parameter estimate update value 65 are shifted away from each other. Thus, it can be said that the parameter estimate corresponding to Expression (2) estimated in Section B, that is, an acquisition section for the input u and the output actual measurement value y used to calculate the parameter estimate corresponding to Expression (2) is unsuitable for system identification.

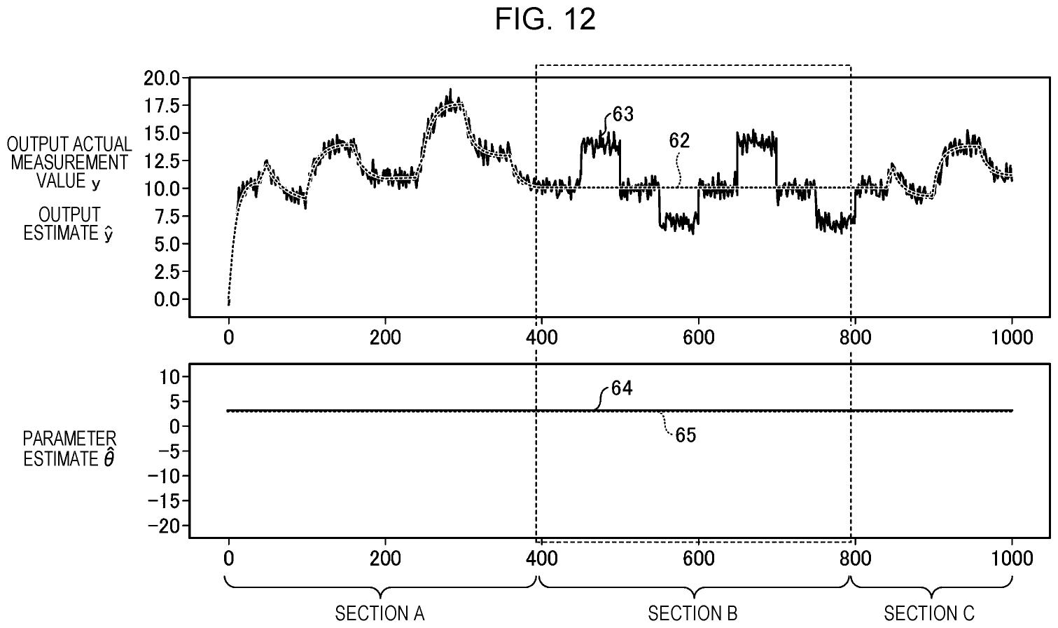

Subsequently, FIG. 12 illustrates plots of the output actual measurement value y and the output estimate corresponding to Expression (3), and parameter estimate variations output by the information processing apparatus 100. In FIG. 12, first, in Section A and Section C, which are not affected by the disturbance d, criteria for the posterior variance evaluation, the output estimate tracking accuracy evaluation, and the parameter estimate variation evaluation of this method are all satisfied. Thus, the determination unit 134 determines using this method that data sets in Section A and Section C are suitable for system identification. In actuality, in FIG. 12, the plot 62 of the output estimate corresponding to Expression (3) follows the plot 63 of the output actual measurement value y with high accuracy in Section A and Section C, and the parameter true value 64 and the parameter estimate update value 65 for the parameter estimate corresponding to Expression (2) match each other. Thus, it can be said that, in Sections A and C, the parameter estimate corresponding to Expression (2), that is, an acquisition section for the input u and the output actual measurement value y used to calculate the parameter estimate corresponding to Expression (2) is suitable for system identification similarly to as in FIG. 11.

In contrast, Section B is affected by the disturbance d, and the criteria for the posterior variance evaluation and the parameter estimate variation evaluation of this method are not satisfied, so that the determination unit 134 determines that an acquisition section for the input u and the output actual measurement value y is unsuitable for system identification, and the update unit 135 does not update the parameter. As a result, the parameter true value 64 and the parameter estimate update value 65 match each other in the entirety of Section B, and the information processing apparatus 100 avoids a misestimation of the parameter estimate corresponding to Expression (2) in Section B.

### 4-2. Second Modification: Parameter Update in Data Section Matching Predetermined Condition

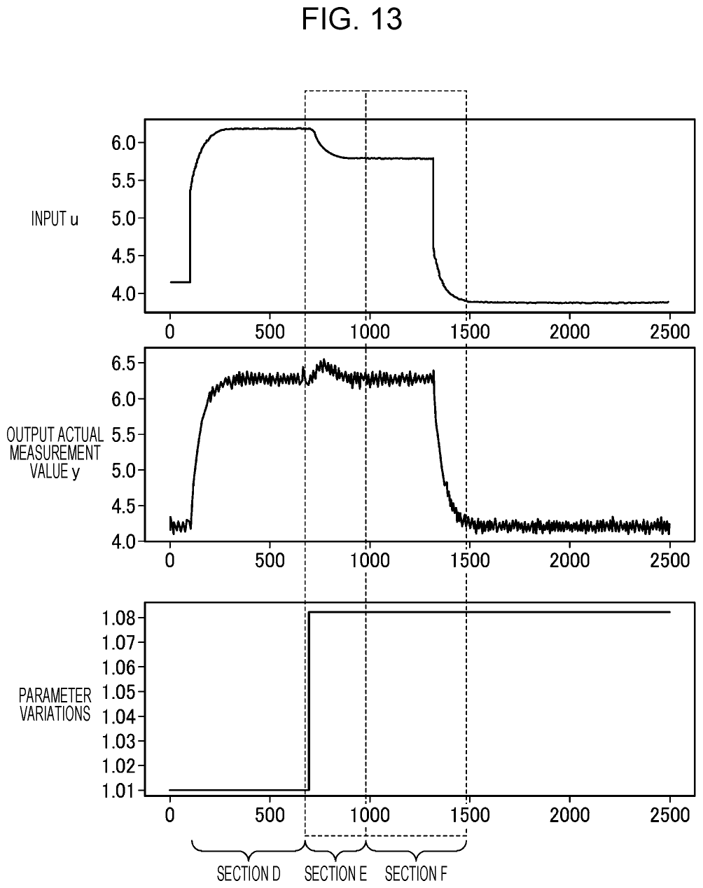

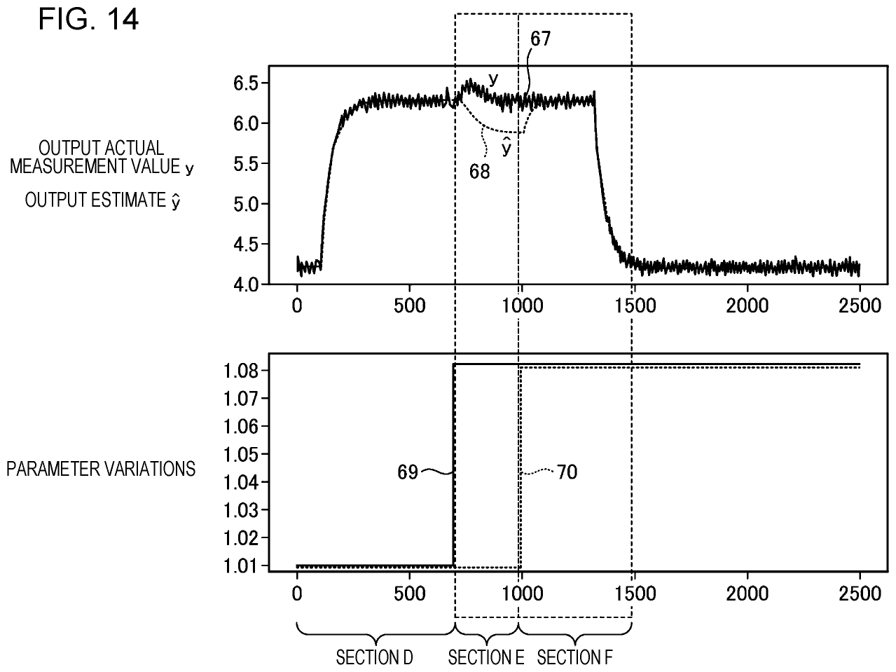

Next, using FIGS. 13 and 14, an example will be described in which the information processing apparatus 100 according to the present disclosure updates the parameter in an acquisition section for the input u and the output actual measurement value y, the acquisition section matching a predetermined condition. First, FIG. 13 illustrates, as prior conditions for a second modification, the input u serving as one input, the output actual measurement value y serving as one output, and variations in the parameter corresponding to Expression (1). The input u and the parameter corresponding to Expression (1) vary in Section E, and thus it is desirable that the parameter be updated in Section F, which is suitable for system identification.

Next, FIG. 14 illustrates, on the basis of conditions for FIG. 13, plots of the output actual measurement value y and the output estimate corresponding to Expression (3), and variations in a parameter true value 69 and those in a parameter estimate update value 70. First, the parameter corresponding to Expression (1) varies in Section E; however, a criterion for the posterior variance evaluation of this method is not satisfied. Thus, the determination unit 134 determines that Section E is unsuitable for system identification. As a result, an acquisition section including Section E is determined to be unsuitable for system identification. Thus, the update unit 135 does not update the parameter estimate corresponding to Expression (2) acquired from this acquisition section. As a result, regarding a plot 67 of the output actual measurement value y and a plot 68 of the output estimate corresponding to Expression (3), the parameter corresponding to Expression (1) varies, so that tracking accuracy decreases. However, in Section F, criteria for the posterior variance evaluation, the output estimate tracking accuracy evaluation, and the parameter estimate variation evaluation of this method are all satisfied. Thus, the information processing apparatus 100 determines that Section F and the parameter estimate corresponding to Expression (2) are suitable for system identification, and updates a parameter estimate update value 70 such that the parameter estimate update value 70 becomes equal in level to the parameter true value 69. As a result, tracking accuracy in Section F and subsequent sections is equal in level to that in Section D.

### 5. Effects

In an existing technology, an identification data set suitable for system identification needs to be collected by operating a certain process in a test mode or the like, and there may be a case where time and financial costs matter. Furthermore, when the input u varies in an acquisition section for an identification data set acquired in advance, it is necessary to make a determination by, for example, visually checking whether or not the output actual measurement value y is significantly varied, and processing such as extraction of data from the input u needs to be performed as needed. Moreover, even if it is determined through visual check or the like that the output actual measurement value y is significantly varied when the input u described above is varied, a parameter estimation needs to be actually performed using the method of least squares to evaluate an acquired parameter estimate in order to determine whether or not an identification data set or an acquisition section for the identification data set is suitable for system identification.

In addition, in an evaluation for determining whether the identification data set or the acquisition section for the identification data set is suitable for system identification, an engineer or the like who has deep knowledge and skills regarding parameter estimation needs to check, regarding the parameter estimate obtained using the method of least squares, “whether the output estimate obtained using the parameter estimate is following the output actual measurement value” or “whether the parameter estimate has a value on an appropriate order by experience”, for example.

However, as described above, the information processing apparatus 100 estimates, using Bayesian inference, a posterior distribution of a parameter estimate on the basis of an identification data set, performs an evaluation based on the variance of the posterior distribution of the parameter estimate, the output tracking accuracy evaluation, and the parameter estimate variation evaluation, and determines whether the identification data set or an acquisition section for the identification data set is appropriate for use in system identification. Thus, even if the information processing apparatus 100 does not have any deep knowledge or technique regarding parameter estimation, every time the information processing apparatus 100 acquires an identification data set, the information processing apparatus 100 systematically determines whether the acquired identification data set or an acquisition section for the identification data set is appropriate for use in system identification.

From description above, since the information processing apparatus 100 automatically determines from a parameter estimate whether an identification data set corresponds to an identification data set acquisition section that is appropriate for use, the information processing apparatus 100 provides an effect in that identification data sets or identification data set acquisition sections unsuitable for system identification can be excluded.

Moreover, the information processing apparatus 100 automatically determines whether the identification data set is an identification data set with which the accuracy of a parameter estimate does not satisfy a predetermined criterion, and thus provides an effect in that identification data sets unsuitable for system identification can be excluded.

Furthermore, the information processing apparatus 100 automatically determines whether or not the parameter estimate is a parameter estimate that satisfies predetermined conditions in the posterior variance evaluation and the output tracking accuracy evaluation but is not a true value, and thus provides an effect in that identification data sets unsuitable for system identification can be excluded.

Furthermore, the present disclosure has the function of automatically and systematically excluding a data set unsuitable for system identification as described above, and provides an effect in that even an engineer or the like who does not have deep knowledge and skills regarding parameter estimation can achieve system identification with high accuracy and with relatively low cost.

### 6. Hardware Configuration

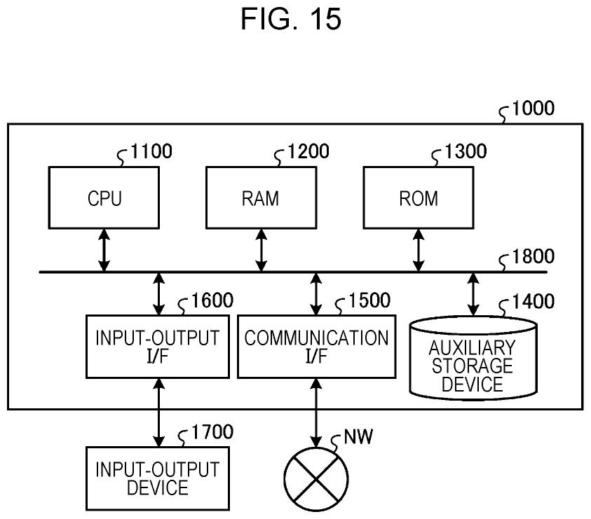

The information processing apparatus 100 according to the present embodiment described above is realized by, for example, a computer 1000 having a configuration as illustrated in FIG. 15. FIG. 15 is a hardware configuration diagram illustrating an example of a computer that realizes the functions of the information processing apparatus 100. The computer 1000 has a configuration in which a central processing unit (CPU) 1100, a random access memory (RAM) 1200, a read-only memory (ROM) 1300, an auxiliary storage device 1400, a communication interface (I/F) 1500, and an input-output I/F 1600 are connected to each other by a bus 1800.

The CPU 1100 operates on the basis of a program stored in the ROM 1300 or the auxiliary storage device 1400 and controls various units. The ROM 1300 stores, for example, a boot program for the CPU 1100 to execute when the computer 1000 is started up, or a program specific to the hardware of the computer 1000.

The auxiliary storage device 1400 stores, for example, a program for the CPU 1100 to execute, and data or the like to be used by the program. The communication I/F 1500 receives data from another device via a certain communication network, sends the data to the CPU 1100, and transmits data generated by the CPU 1100 to another device via a certain communication network. The CPU 1100 controls, via the input-output I/F 1600, an output device such as a display or a printer, and an input-output device 1700 such as a keyboard or a mouse. The CPU 1100 acquires data from the input-output device 1700 via the input-output I/F 1600. Moreover, the CPU 1100 outputs generated data to the input-output device 1700 via the input-output I/F 1600.

For example, in a case where the computer 1000 serves as the information processing apparatus 100 according to the present embodiment, the CPU 1100 of the computer 1000 realizes the functions of the control unit 130 by executing a program loaded onto the RAM 1200.

### 7. Others

Among the individual processing operations described in the above-described embodiments and modifications, all or one or more of the processing operations described as being performed automatically can be performed manually. Alternatively, all or one or more of the processing operations described as being performed manually can be automatically performed using known methods. In addition, the processing procedures, the specific names, and information including various types of data or parameters described herein or in the drawings can be freely changed unless otherwise stated. For example, various types of information illustrated in the individual drawings are not limited to the information illustrated in the drawings.

Moreover, the constituent elements of the illustrated devices are based on functional concepts, and are not necessarily physically constituted as illustrated in the drawings. That is, specific embodiments regarding separation and integration of the individual devices are not limited to those illustrated in the drawings. All or one or more of the devices can be functionally or physically constructed through separation and integration in freely selected units in accordance with, for example, various types of load or use status.

The above-described constituent elements include elements that those skilled in the art can easily conceive, and substantially the same elements, that is, so-called equivalents. Furthermore, the above-described embodiments and modifications can be combined as appropriate as long as a contradiction does not arise in processing details.

Moreover, the above-described “section”, “module”, and “unit” can be read as “mean”, “circuit”, or the like. For example, the “control unit” can be read as a “control means” or a “control circuit”.

Some of the embodiments of the present disclosure have been described above in detail on the basis of the drawings; however, these embodiments are examples, and the present disclosure can be executed as not only the embodiments described in the field of the disclosure of the disclosure but also other embodiments to which various modifications and improvements are added on the basis of the knowledge of those skilled in the art.

What is claimed is:

1. An information processing apparatus comprising:
an estimation unit that estimates a posterior distribution of a parameter estimate using an identification data set for system identification;
an evaluation unit that performs an evaluation based on a variance of the posterior distribution of the parameter estimate, and an output tracking accuracy evaluation for a case where the parameter estimate is used; and
a determination unit that determines, based on evaluation results from the evaluation unit, whether an extraction section for the identification data set is appropriate for use in system identification.

2. The information processing apparatus according to claim 1,
wherein the estimation unit estimates, using the identification data set and based on Bayesian inference, a posterior distribution of a parameter estimate.

3. The information processing apparatus according to claim 1,
wherein, regarding the posterior distribution of the parameter estimate, the evaluation unit performs, using the sum of squared errors, the output tracking accuracy evaluation for a case where the parameter estimate is used.

4. The information processing apparatus according to claim 1,
wherein the evaluation unit performs a parameter estimate variation evaluation as to whether or not the parameter estimate is included in a predetermined range, which is a comparison target, of the posterior distribution of a parameter estimate at a different point in time is evaluated.

5. The information processing apparatus according to claim 4,
wherein in a case where evaluation results from the evaluation based on the variance of the posterior distribution of the parameter estimate, the output tracking accuracy evaluation for a case where the parameter estimate is used, and the parameter estimate variation evaluation satisfy predetermined conditions, the determination unit determines whether the extraction section for the identification data set is appropriate for use in system identification.

6. The information processing apparatus according to claim 1, further comprising:
an update unit that updates, in a case where the determination unit determines that a predetermined condition is satisfied, a parameter of a model using an average value of the posterior distribution of the parameter estimate.

7. An information processing method comprising:
estimating a posterior distribution of a parameter estimate using an identification data set for system identification;
performing an evaluation based on a variance of the posterior distribution of the parameter estimate, and an output tracking accuracy evaluation for a case where the parameter estimate is used; and
determining, based on evaluation results from the evaluation unit, whether an extraction section for the identification data set is appropriate for use in system identification.

8. An information processing program causing a procedure to be executed, the procedure comprising:
estimating a posterior distribution of a parameter estimate using an identification data set for system identification;
performing an evaluation based on a variance of the posterior distribution of the parameter estimate, and an output tracking accuracy evaluation for a case where the parameter estimate is used; and
determining, based on evaluation results from the evaluation unit, whether an extraction section for the identification data set is appropriate for use in system identification.
